(19) United States
(12) Patent Application Publication
(10) Pub. No.: US 2015/0253296 A1
(43) Pub. Date: Sep. 10, 2015

(54) METHOD FOR DETECTING ANALYTES

(71) Applicant: METROHM AG, Herisau (CH)

(72) Inventors: Björn Christensen, Speicherschwendi (CH); Sven Hoffmann, Schwellbrunn (CH); Thomas Moritz, Herisau (CH)

(21) Appl. No.: 14/432,227

(22) PCT Filed: Sep. 30, 2013
(86) PCT No.: PCT/EP2013/070309

§ 371 Date: Mar. 30, 2015

(30) Foreign Application Priority Data
Oct. 3, 2012 (EP) 12187111.5

(51) Int. Cl. G01N 30/74

(52) U.S. Cl. CPC G01N 30/74

(57) ABSTRACT

A method for detecting analytes in flow rate analysis and chromatography is described. The method comprises the following steps: a) providing one or more light sources, an optical wave guide, a container containing a specimen with one or more analytes, and one or more detectors; b) exposing the container containing the specimen to light of one or various, defined wavelengths and/or wavelength ranges; and c) detecting the resulting light waves by one or more detectors after the specimen container is exposed to light of one or various defined wavelengths and/or wavelength ranges, wherein the specimen is irradiated by transferring the light waves through an non-flexible or non-flexibly arranged optical wave guide before the light waves enter the specimen container. The non-flexible or non-flexibly arranged optical wave guide is not susceptible to interference and permits selective irradiation with one or more wavelengths sequentially or simultaneously without requiring much time.

This application is a National Stage completion of PCT/EP2013/070309 filed Sep. 30, 2013, which claims priority from European patent application serial no. 12187111.5 filed Oct. 3, 2012.

### FIELD OF THE INVENTION

The present invention relates to a method, for detecting analytes in chromatography, in particular in ion and liquid chromatography, wherein the method, comprises the transmission of light waves through non-flexible optical waveguides. Moreover, the invention relates to the use of non-flexible optical waveguides for transmitting light waves when detecting analytes in chromatography, in particular in ion and flow chromatography, and in continuous flow analysis (CFA), in particular in segmented flow analysis (SFA), flow injection analysis (FIA) and sequential injection analysis (SLA).

### BACKGROUND OF THE INVENTION

The methods known in the prior art for detecting analytes with the aid of light waves make use of different processes for transmitting light, waves. In conventional methods, use is made of light sources which cover broad regions of the spectrum. Use is made of interference filters for selectively irradiating samples with individual wavelengths or wavelength regions. A disadvantage of these methods consists of the fact that it is not possible to carry out a process of irradiation at a plurality of defined wavelengths or narrow wavelength regions at the same time. Moreover, a filter change is too time-consuming for flowing samples.

US 2011/0188042 A1 describes a method for the spectroscopic analysis of samples, in particular for absorption and fluorescence spectroscopy. In this method; light-emitting diodes with individual wavelengths are used as light sources, the emitted light waves of which are guided through various individual optical fiber cables, which are only bunched together, to a sample cell, which can also be a flow cell. The transmitted or fluorescence light is subsequently acquired by individual or a plurality of photodiodes.

It was found that such a setup was relatively susceptible to faults, in particular in relation to mechanical influences.

Betschon et al., Novel Optical Titration Sensor based on Integrated Planar Polymer Waveguides, SENSOR+TEST Conferences 2011, OPTO Proceedings, 4.2, describes an optical sensor which is used in titration and contains a planar optical waveguide integrated, in a printed, circuit board. The light sources, the optical waveguide, as well as the detector are situated on a printed circuit board, which is integrated into a glass rod. The latter is held in the titration vessel, in which analytes are situated, during a titration. This device does not solve the problem of measuring analytes in solutions which are flowing, as is the case for example in liquid chromatography or continuous flow analysis (CFA).

### SUMMARY OF THE INVENTION

The present invention is therefore based on the object of avoiding the disadvantages of the prior art, in particular of developing a detection method tor analytes in continuous flow analysis (CFA) and chromatography, in particular in liquid chromatography, which method enables the irradiation of samples with light of one or more wavelengths simultaneously, selectively and without being time consuming. Furthermore; the method should not be susceptible to errors, e.g. by mechanical influences, and it should be sensitive enough to detect analytes in small quantities.

A first aspect of the invention relates to a method for detecting analytes in continuous flow analysis (CFA) and chromatography, comprising
a) the provision of one or sore light sources, an optical waveguide, a container containing a sample with one or more analytes and one or more detectors,
b) the exposure of the container containing the sample to the light of one wavelength or different defined wavelengths and/or wavelength regions, and
c) the acquisition of the resulting light waves by means of one or more detectors after exposing the sample container to the light of one wavelength or different defined wavelengths and/or wavelength regions, wherein the sample is irradiated by virtue of the light waves being transmitted prior to entry into the sample container through a single, possibly branched, non-flexible optical waveguide.

The aforementioned method can, in particular, be applied to continuous flow analysis (CFA) and ion and flow chromatography. The analytes can be compounds containing chromophores and/or ions, which absorb wavelengths or wavelength regions from at least one of the visible, UV, IR or NIR light spectral ranges, fluoresce as a result of these or reflect these.

The provided light source or light sources can be tungsten lamps, lasers and/or light-emitting diodes. Lasers and light-emitting diodes are particularly preferred. They emit light with defined wavelengths or narrowly defined wavelength regions from the visible, the UV, IR and NIR region, which light is guided through an optical waveguide. Subsequently, a sample container containing a liquid sample with at least one analyte is exposed to this light of one wavelength or different defined wavelengths and/or wavelength regions. The sample can be irradiated selectively with light of only one wavelength or of a plurality of wavelengths or wavelength regions simultaneously; since the light sources can be switched on and off independently of one another.

The container particularly preferably is a flow cell which comprises both an inlet and an outlet, through which a liquid sample flows in and out again with a flow rate between 10 μl/min and 10 μl/min. The container comprises an entry window and exit window for entering and exiting light, in particular consisting of glass, plastic or quartz, which is configured in such a way that it is transmissive for defined wavelength regions.

After the sample container containing a liquid sample with at least one analyte was irradiated by light from the light source, which is transmitted by way of the optical waveguide, the resulting light can be transmitted light, reflected light or fluorescence light. The light is acquired by one or more detectors after its passage through the container, after reflection or after it was emitted by fluorescence.

Here, the measuring interval, in which the detector acquires resulting light waves, preferably occurs during the switching time of the light source, but it starts after the start of the irradiation of the sample. In one possible embodiment, the measurement is only started when half of the time of the radiation interval has elapsed. The measuring interval also ends with the end of the radiation interval.

In a further method step, a further measurement of the signal strength is performed after the end of the radiation interval. This second measurement, which is not undertaken during the irradiation, serves to allow the established, dropped-off signal intensities to be subtracted from the intensities measured during the irradiation so as to eliminate the background signals, which falsify the result, in this manner.

A further method step following the establishment of the light wave signals comprises a mathematical evaluation method, by means of which the acquired signals, which constitute the response to a plurality of wavelengths emitted sequentially or simultaneously, are evaluated.

The utilized detector or detectors are, in particular, vacuum photocells, radiation thermocouples, photomultipliers and/or photodiodes. Use is particularly preferably made of photodiodes, in particular CCD and CMOS sensors.

In particular, the optical waveguide according to the invention can be attached onto, or integrated into, a printed circuit board. This is distinguished by virtue of the fact that it, on its own or in a combination comprising a printed circuit board with an optical waveguide attached thereon or integrated therein, is not flexible and is preferably planar. In this context, non-flexible means that the optical waveguide or optical waveguide comprising the printed circuit board is not pliable enough for bending, which leads to losses during the transmission of light or to irreversible damage, to be possible. This property eliminates the susceptibility to faults in relation to mechanical influences. Thus, bending an optical fiber in a radius of more than 200-times the diameter thereof brings about transmission losses. What was found within the scope of the invention is that the rigid arrangement or fixation of the optical waveguide improves the reproducibility and the sensitivity of a sensor according to the invention. Irreversible damage occurs in optical fibers from bending in a radius of more than 600-times the diameter thereof.

Within the scope of the invention, printed circuit boards, onto which an optical waveguide is attached or into which the latter is integrated, can be manufactured from, in particular, an epoxy resin with optical fiber tissue (e.g. FR4) and preferably have a transverse flexural strength in the region of 600 N/mm to 200 N/mm, preferably 500 N/mm to 300 N/mm, and have a longitudinal flexural strength in the region of 600 N/mm to 200 N/mm, preferably 500 N/mm to 300 N/mm.

The optical waveguides can also be integrated, into polyimide printed circuit boards, which are laminated onto substrates which have the aforementioned flexural strengths.

The optical waveguide is a single guide through which the light, waves from different light sources with different wavelengths are guided. Optionally, the optical waveguide may be branched, i.e. the light waves enter the optical waveguide at different points along the length of the optical waveguide.

Additionally, one or more light sources, in particular light-emitting diodes, can be attached onto, in particular integrated into, the printed, circuit board.

Here, the printed circuit board with integrated optical waveguide can be constructed as follows: The printed circuit board with the electronic components for evaluating an optical signal assembled thereon constitutes the lowermost layer. Arranged thereon is the so-called optical layer, i.e. the optical waveguide setup. The optical waveguide comprises a backing layer, a core layer and a coating layer. The core layer comprises the light-guiding structures.

All three layers can be manufactured from optically transparent, UV curing polymer materials, wherein the polymer of the core layer differs from those of the backing and coating layers which, in turn, may respectively be different or the same. Inter alia, polycarbonate and PMMA can be used as materials for the polymer layers.

The refractive index for visible light of the core layer is higher than the refractive indices of the backing and coating layers and preferably lies between 1.50 and 1.60. Typical refractive indices for the backing layer and coating layer lie between 1.47 and 1.57.

The backing and coating layers each typically have a layer thickness from 10 μm to 500 μm, preferably between 50 and 200 μm. The core layer can have a layer thickness of between 1 μm and 500 μm.

A method for producing typical optical waveguides is described in the patent application EP 2 219 059 A2.

With the aid of an adhesive matched to the refractive index of the core layer, one or more LED light sources are cast onto the upper side of the printed circuit board and arranged in relation to the core layer in such a way that the radiation emitted by such LED light sources can be coupled into the optical waveguide. Here, coupling can be brought about by means of a component for optical coupling, the production of which is described in e.g. EP 1 715 363 B1. A printed circuit board particularly preferably comprises only one optical waveguide, into which the light of a plurality of light sources is coupled.

A flow cell is arranged at an angle of between 70° and 110°, preferably at an angle of 90°, in relation to the exit surface of the light from the optical waveguide. Here, it is not necessary to couple the light by means of a coupling element. Rather, the optical waveguide is matched with precise fit to a wall of the flow cell. Moreover, connection materials such as an adhesive are not required between the flow cell and the optical waveguide. This setup differs from conventional photodiode array detectors, which comprise complicated and expensive lens systems as coupling elements.

The detector, which acquires the light waves resulting after irradiation of the sample, can likewise be arranged, on the printed circuit board.

The printed circuit board comprising the optical waveguide or the optical waveguide and the light source or light sources is enclosed by a light-opaque and/or thermally conductive cover in a particularly preferred embodiment. The latter serves for protect ton against temperature variations, in particular in order not to adversely affect the power of the light sources, and for shielding from scattered light. Preferably, a metal housing, in particular an aluminum housing, is used for the cover. The housing can additionally be provided with cooling, in particular Peltier cooling.

Moreover, the present invention also comprises the use of a non-flexible optical waveguide for transmitting light waves during the detection of analytes in continuous flow analysis (CFA) and chromatography, in particular in ion and/or liquid chromatography. The optical waveguide, the wavelengths or wavelength regions of the transmitted light waves and the analytes are as described above. The sensitivity and reproducibility of the setup according to the invention surprisingly permits use not only in a stationary system such as a photometer, but also in the flow cell.

### BRIEF DESCRIPTION OF THE DRAWINGS

The invention will be described in detail below on the basis of exemplary embodiments and figures, without the subject matter of the invention being intended to be restricted to the preferred embodiment. In detail:

FIG. 1: Schematic illustration of the setup of a printed circuit board with an optical waveguide, light source and flow cell attached thereon or integrated therein.

FIG. 2a: Schematic illustration of an unbranched optical waveguide.

FIG. 2b: Schematic illustration of a branched optical waveguide.

FIG. 3: Radiation cycle of an LED light source.

FIG. 4: Measurement cycle of the light detector.

FIG. 5: Diagram of the measurement cycle when irradiating a sample in flow injection analysis with the aid of a plurality of LED light sources.

FIG. 6: Chromatogram of a chromium diphenylcarbazole solution.

### DETAILED DESCRIPTION OF THE PREFERRED EMBODIMENTS

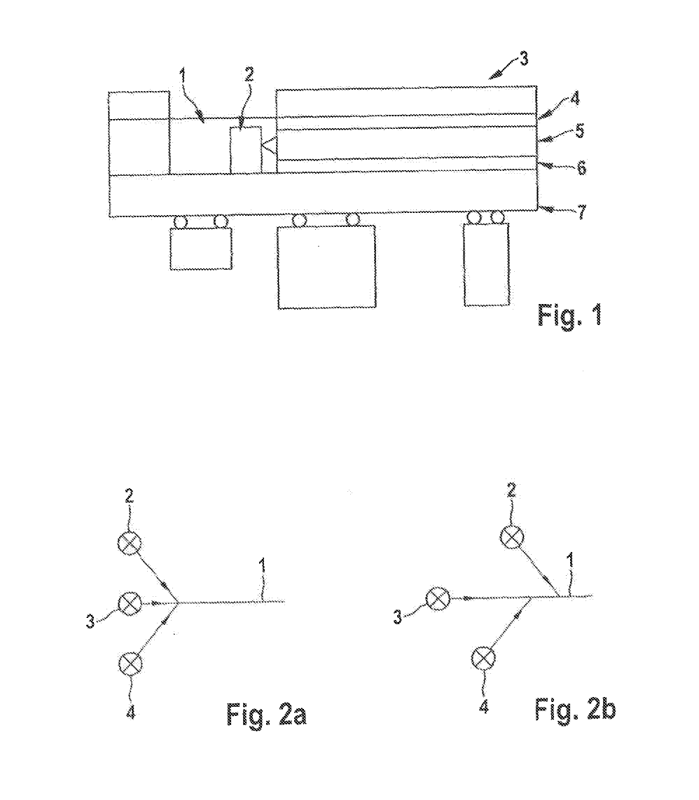

FIG. 1 depicts the schematic setup of a printed circuit board. The printed circuit board with the electronic components for evaluating an optical signal assembled thereon constitutes the lowermost layer (7). Arranged thereon is the so-called optical layer, i.e. the optical waveguide setup. The optical waveguide comprises a backing layer (6), a core layer (5) in the center and a coating layer (4) at the top. The core layer (5) comprises the light-guiding structures. With the aid of an adhesive (1) matched to the refractive index of the core layer, one or more LED light sources (2) are cast onto the upper side of the printed circuit board and arranged in relation to the core layer in such a way that the radiation emitted by such LED light sources can be coupled into the optical waveguide. Here, coupling is brought about by means of a component, for optical coupling, the production of which is described in EP 1 715 368 B1. A printed, circuit board comprises only one optical waveguide, into which the light of a plurality of light, sources is coupled. The layer denoted by (3) represents the carrier material of the optical waveguide. FIG. 1 does not depict the flow cell containing the analyte or analytes, which are irradiated by the light from the optical waveguide, and the detector or detectors.

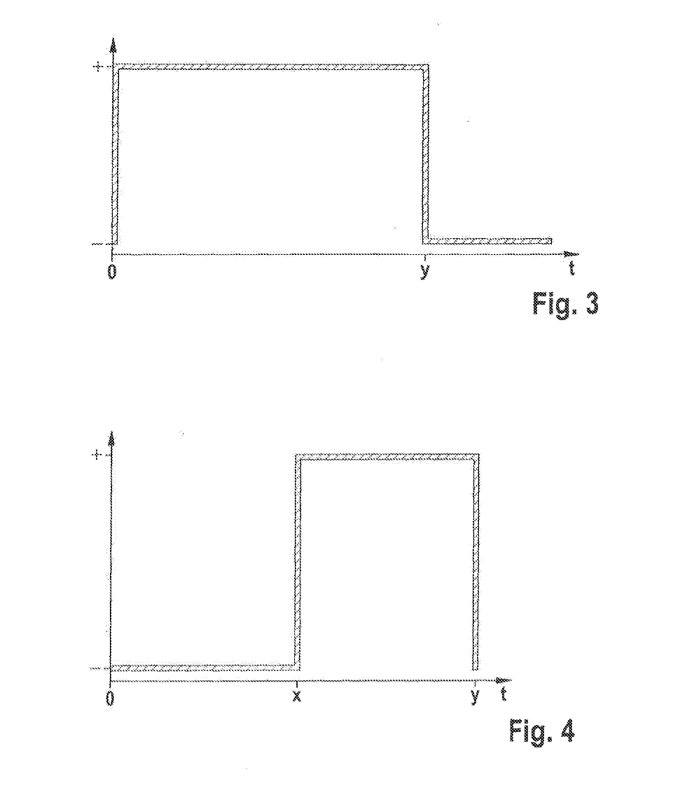

FIG. 2 shows, on the left-hand side, a schematic illustration 2a of an unbranched optical waveguide 1, into which light waves from the light sources 2, 3 and 4 enter in the direction of the arrow at one point. The schematic illustration 2b shows a branched setup of the optical waveguide 1, into which light waves from the light sources 2, 3 and 4 enter in the direction of the arrow at different points along the length of the optical waveguide 1.

FIG. 3 shows the radiation cycle by an LED light source. The x-axis plots the time, the symbols and “+” and “−” on the y-axis specify that the light source is in the switched-on state in the “+” position and in the switched-off state in the “−” position. The LED light source is switched on in the time interval from 0 to y.

FIG. 4 shows the measurement cycle of the light detector during the time interval of the radiation cycle of the light source. The x-axis plots the time, the y-axis plots the specification as to whether the LED light source is in the switched-on (“+”) or switched-off (“−”) state. The LED light source is switched on during the time interval from 0 to y. The time interval x to y is the period of time during which the light sensor is switched on. There is no detection or measurement of the light signals in the interval from 0 to x.

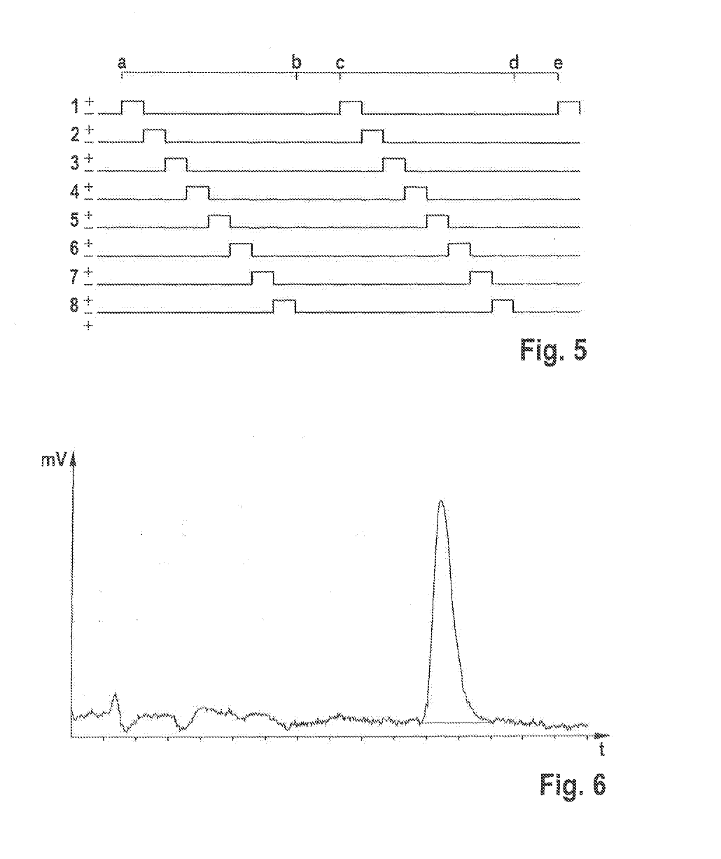

FIG. 5 shows a diagram which depicts the time t on the x-axis and the switching cycles of various LED light sources on the y-axis. The individual light sources 1 to 8 are successively switched on and off over intervals in a time offset manner. The respective LSD light, source is switched off in the “−” position and switched on in the “+” position, which are specified on the y-axis. Various measurement cycles are specified on the x-axis from “a” to “e”. A measurement cycle which is composed of at switching cycle of the LSD light sources 1 to 8 and a cycle for determining the background signals extends from “a” to “e”. The light passing through the irradiated sample is measured by a detector during the time interval from “a” to “b”. To this end, the LED light sources 1 to 8 are successively switched on and off. The background signal is established in the time interval from “b” to “c” on the x-axis, during which all LED light sources are switched off. The whole measurement cycle is repeated in the time interval from “c” to “e”.

FIG. 6 snows an exemplary chromatogram of a 5 ppb chromium diphenylcarbazole solution, measured using the method according to the invention. Here, 12 mmol/L Na₂CO₃ and 4.0 mmol/L NaHCO₃ with a flow rate of 0.8 mL/min were used as an eluent in a Metrosep A Supp 5-100/4.0 column at a column temperature of 40° C.

The measurement interval was 3 ms with a delay time of 2 ms and a cycle pause of 3 ms at a wavelength of 520±15 nm. The measured signal height is approximately 7.73 mV with a signal noise of approximately 0.3 mV. The elution time is t=5.73 min. The signal-to-noise ratio is approximately 1:26.

1-15. (canceled)

16. A method for detecting analytes in continuous flow analysis and chromatography, the method comprising the steps of:
a) providing one or more light sources, an optical waveguide, a container containing a sample with one or more analytes and one or more detectors,
b) exposing of the container, containing the sample, to the light of one wavelength or different defined wavelengths or wavelength regions, and
c) acquiring resulting light waves by one or more detectors after exposing the sample container to the light of one wavelength or different defined wavelengths or wavelength regions,
wherein the sample is irradiated by virtue of the light waves being transmitted prior to entry into the sample container through a single non-flexible or not flexibly arranged optical waveguide.

17. The method as claimed in claim 16, wherein the chromatography is ion chromatography.

18. The method as claimed in claim 16, wherein the container is a flow cell.

19. The method as claimed in claim 16, wherein the light sources are LEDs.

20. The method as claimed in claim 16, wherein the optical waveguide comprises a backing layer, a core layer and a coating layer.

21. The method as claimed in claim 20, wherein the coating and backing layers comprise a polymer with a refractive index of 1.47 to 1.5 and the core layer comprises a polymer with a refractive index of 1.40 to 1.50.

22. The method as claimed in claim 16, wherein the optical waveguide or the light source or light sources are attached onto a printed circuit board.

23. The method as claimed in claim 16, wherein the optical waveguide or the light source or light sources are integrated into a printed circuit board.

24. The method as claimed in claim 22, wherein the printed circuit board is covered by a light-opaque cover, at least in the region of the optical waveguide.

25. The method as claimed in claim 22, wherein the printed circuit board is covered by a thermally conductive cover, at least in the region of the optical waveguide.

26. The method as claimed in claim 16, wherein the light waves to be acquired after irradiating the sample may result from transmitted light, reflection or fluorescence.

27. The method as claimed in claim 16, wherein the detector is one or more photodiodes.

28. The method as claimed in claim 27, wherein the detector is a CCD sensor.

29. The method as claimed in claim 16, when the measuring interval of the detector starts during the switching time of the light source and after the sample has started to be irradiated.

30. The method as claimed in claim 29, wherein a further measuring interval occurs after the irradiation is completed.

31. The method as claimed in claim 16, wherein the acquired signals of a plurality of sequentially or simultaneously emitted wavelengths are evaluated in a further method step using a mathematical evaluation method.
